(19) United States
(12) Patent Application Publication
(10) Pub. No.: US 2019/0004376 A1
(43) Pub. Date: Jan. 3, 2019

(54) ALIGNMENT MATERIAL COMPOSITION, LIQUID CRYSTAL DISPLAY (LCD) PANEL, MANUFACTURING METHOD THEREOF AND DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu ,Sichuan (CN)

(72) Inventors: Xi XIANG, Beijing (CN); Ni JIANG, Beijing (CN); Yuanming FENG, Beijing (CN)

(73) Assignees: BOE TECHNOLOGY GROUP CO., LTD., Beijing (CN); CHENGDU BOE OPTOELECTRONICS TECHNOLOGY CO., LTD., Chengdu ,Sichuan (CN)

(21) Appl. No.: 15/748,397

(22) PCT Filed: Jun. 30, 2017
(86) PCT No.: PCT/CN2017/091184

§ 371 Date: Jan. 29, 2018

(30) Foreign Application Priority Data
Nov. 29, 2016 (CN) 201611072258.8

(51) Int. Cl. G02F 1/1337; G02F 1/1335; G02F 1/01

(52) U.S. Cl. CPC G02F 1/133703; G02F 1/0107; G02F 1/133711; G02F 1/133514

(57) ABSTRACT

Embodiments of the present disclosure relate to an alignment material composition, a liquid crystal display (LCD) panel, a manufacturing method thereof and a display device. The alignment material composition includes: about 89 wt %-94.9 wt % of an organic solvent; about 0.1 wt-1 wt % of an organic additive; and about 5 wt %-10 wt % of polyimide resin, and the organic additive is capable of absorbing ultraviolet (UV) light of wavelength from about 290 nm to about 400 nm.

### TECHNICAL FIELD

Embodiments of the present disclosure relate to an alignment material composition, a liquid crystal display (LCD) panel, a manufacturing method thereof and a display device.

### BACKGROUND

LCD has become a mainstream product in flat-panel displays due to the characteristics of small volume, low power consumption, non-radiation, etc. LCD panel is an important component of the LCD. The current LCD panel comprises an array substrate, a color filter (CF) substrate opposed to the array substrate, and liquid crystals sealed between the array substrate and the CF substrate. The CF substrate and the array substrate are combined together via sealant to form a liquid crystal cell.

In the manufacturing process of the LCD panel, a uniform alignment layer is usually adopted to realize the alignment of liquid crystal molecules, and the alignment uniformity of the liquid crystal molecules directly affects the quality of the LCD. The rubbing alignment technology and the photo-alignment technology are currently mainly adopted to process the alignment layer to align the liquid crystal molecules.

### SUMMARY

An embodiment of the present disclosure provides an alignment material composition, comprising: about 89 wt %-94.9 wt % of an organic solvent; about 0.1 wt %-1 wt % of an organic additive; and about 5 wt %-10 wt % of polyimide resin, wherein the organic additive is capable of absorbing ultraviolet (UV) light of wavelength from about 290 nm to about 400 nm.

In an embodiment of the present disclosure, for example, the organic additive comprises a benzotriazole compound represented by following formula:

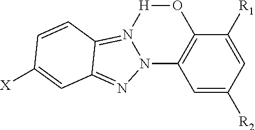

wherein, X is selected from the group consisting of H, F, Cl, Br and I; R1 is selected from the group consisting of H and C₄-C₁₂ alkyl isomer; and R₂ is selected from the group consisting of CH₃ and C₄-C₈ alkyl isomer.

In an embodiment of the present disclosure, for example, the organic additive comprises:

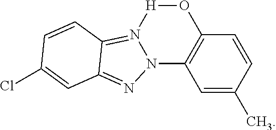

In an embodiment of the present disclosure, for example, a mass percentage of the organic additive to the alignment material composition is about 0.5 wt %-0.8 wt %.

In an embodiment of the present disclosure, for example, a mass percentage of the organic additive to the alignment material composition is about 0.6 wt %.

In an embodiment of the present disclosure, for example, a mass percentage of the polyimide resin to the alignment material composition is about 6 wt %-8 wt %.

In an embodiment of the present disclosure, for example, the organic solvent comprises at least one selected from the group consisting of N-methyl-2-pyrrolidone, γ-butyrolactone and butyl cellosolve.

In an embodiment of the present disclosure, for example, the organic solvent comprises N-methyl-2-pyrrolidone, γ-butyrolactone and butyl cellosolve; and in the alignment material composition, a mass percentage of N-methyl-2-pyrrolidone is about 15 wt %-20 wt %, a mass percentage of γ-butyrolactone is about 60 wt %-70 wt %, and a mass percentage of butyl cellosolve is about 10 wt %-15 wt %.

An embodiment of the present disclosure provides a liquid crystal display (LCD) panel, comprising: a first substrate and a second substrate opposed to each other; liquid crystals between the first substrate and the second substrate; and an alignment layer disposed on a surface of at least one of the first substrate and the second substrate, which surface is close to the liquid crystals, wherein the alignment layer comprises the alignment material composition as described above.

In an embodiment of the present disclosure, for example, in the liquid crystal display (LCD) panel, the alignment layer has a multi-layered structure; and the organic additive is disposed in a layer structure of the alignment layer, which layer structure is away from the liquid crystals and is capable of absorbing UV light.

In an embodiment of the present disclosure, for example, in the liquid crystal display (LCD) panel, the polyimide resin is disposed in a layer structure of the alignment layer, which layer structure is close to the liquid crystals, and is capable of aligning the liquid crystals.

In an embodiment of the present disclosure, for example, in the liquid crystal display (LCD) panel, the first substrate is an array substrate and the second substrate is a color filter (CF) substrate.

An embodiment of the present disclosure provides a display device, comprising the LCD panel described above.

An embodiment of the present disclosure provides a method for manufacturing a liquid crystal display (LCD) panel, comprising: providing a first substrate and a second substrate; coating an layer of the alignment material composition as described above on a surface of at least one of the first substrate and the second substrate; forming an alignment layer by performing a rubbing process on the coated alignment material composition; applying a sealant to at least one of the first substrate and the second substrate; applying liquid crystals to at least one of the first substrate and the second substrate; cell-assembling the first substrate and the second substrate; and curing the sealant.

In an embodiment of the present disclosure, for example, in the method, curing of the sealant includes UV pre-curing and primary thermocuring.

In an embodiment of the present disclosure, for example, in the method, the first substrate and the second substrate are respectively a color filter (CF) substrate and an array substrate; and before coating the layer of the alignment material composition as described above on the surface of at least one of the first substrate and the second substrate, a color filter (CF) structure and an array structure are respectively formed on the first substrate and the second substrate

### BRIEF DESCRIPTION OF THE DRAWINGS

In order to clearly illustrate the technical solution of the embodiments of the disclosure, the drawings of the embodiments will be briefly described in the following, it is obvious that the described drawings are only related to some embodiments of the disclosure and thus are not limitative of the disclosure.

FIG. 1 is a diagram illustrating the manufacturing process of an LCD panel;

FIG. 2 is a schematic structural sectional view of an LCD panel provided by an embodiment of the present disclosure;

FIG. 3 is a flow diagram illustrating the manufacturing process of the LCD panel provided by an embodiment of the present disclosure; and

FIG. 4 is a diagram illustrating the manufacturing process of the LCD panel provided by an embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one.

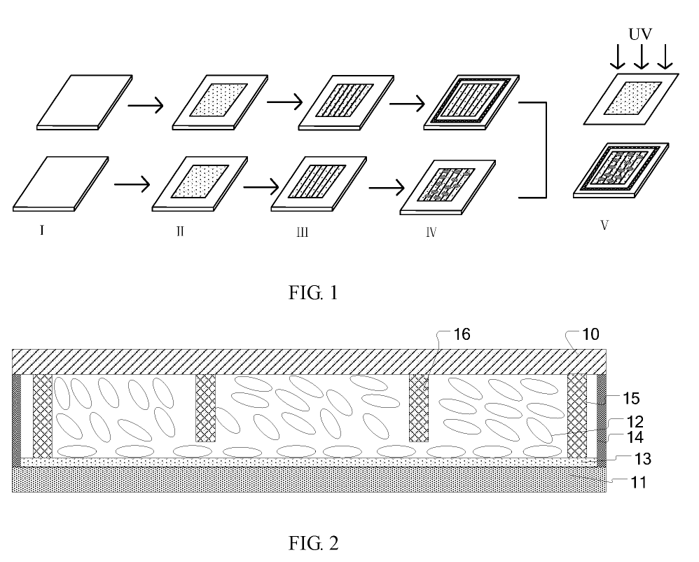

For example, FIG. 1 is a diagram illustrating the manufacturing process of an LCD panel. As illustrated in FIG. 1, the conventional manufacturing process of the LCD panel is as follows: respectively forming an array structure and a CF structure on a first substrate (e.g., a substrate on the lower side in FIG. 1) and a second substrate (e.g., a substrate on the upper side in FIG. 1); respectively coating alignment materials on the first substrate and the second substrate; forming an alignment layer by performing a rubbing process on the alignment materials, so that subsequent liquid crystal molecules can be regularly arranged and aligned; dripping liquid crystals on the first substrate; coating sealant on the second substrate; performing vacuum cell-assembly on the first substrate and the second substrate; performing UV pre-curing and primary thermocuring on the sealant; applying a shielding mask when external light is adopted for pre-curing; and obtaining single LCD panels by cutting along an LCD panel motherboard. The pre-curing of the sealant mostly adopts UV light irradiation. However, when UV light irradiation is adopted for the pre-curing of the sealant, liquid crystals in a display region will be damaged. Therefore, a metal-plated mask is generally employed to shield the display region of the LCD panel in the process. As the size of display regions of different LCD panels is different, corresponding masks must be manufactured for different LCD panels. Thus, the production cost of the LCD panel is increased, and the manufacturing process is complicated.

In addition, more and more attention has been paid to vehicle-mounted LCD panels. When the vehicle-mounted LCD panel is required to be used outdoors for a long period of time, the long-term exposure to UV light irradiation tends to produce yellowish periphery on the display panel, resulting in poor display. Therefore, the capability of the LCD panel in resisting UV irradiation must be further improved.

As described above, a metal-plated mask is usually adopted to shield a display region in the process of adopting UV light irradiation for the pre-curing of sealant. As the size of display regions of different LCD panels is different, corresponding masks must be manufactured for different LCD panels. In this case, the manufacturer needs a plurality of different masks, so the production cost is increased and the manufacturing process is complicated. In order to solve the above problem, the embodiments of the present disclosure provide an alignment material composition and an LCD panel comprising an alignment layer formed by the alignment material composition. The alignment material composition includes: about 89 wt %-94.9 wt % of an organic solvent; about 0.1 wt %-1 wt % of an organic additive; and about 5 wt %-10 wt % of polyimide resin. The organic additive is capable of absorbing ultraviolet (UV) light of wavelength from about 290 nm to about 400 nm.

For example, the alignment material composition not only can form the alignment layer by alignment process but also can effectively block the UV light irradiation on liquid crystal molecules by absorbing UV light. Thus, when the alignment material composition is applied to the LCD panel, corresponding UV light mask is not required to be manufactured for LCD panels with different sizes of display regions. Therefore, the production cost of the LCD panel can be reduced; the manufacturing process of sealant pre-curing can be simplified; the capability of the LCD panel in resisting UV light irradiation can be improved; and the product quality can be improved.

An embodiment of the present disclosure provides an alignment material composition, which comprises: about 89 wt %-94.9 wt % of an organic solvent; about 0.1 wt %-1 wt % of an organic additive; and about 5 wt %-10 wt % of polyimide resin. The organic additive is capable of absorbing ultraviolet (UV) light of wavelength from about 290 nm to about 400 nm.

For example, the organic solvent in the embodiment of the present disclosure comprises at least one selected from the group consisting of N-methyl-2-pyrrolidone, γ-butyrolactone and butyl cellosolve. The organic solvent may be one or more selected from the group consisting of N-methyl-2-pyrrolidone, γ-butyrolactone and butyl cellosolve. Description will be given below by taking the case that the organic solvent simultaneously comprises the above three materials as an example.

For example, in the alignment material composition, a mass percentage of N-methyl-2-pyrrolidone is about 15 wt %-20 wt %; a mass percentage of γ-butyrolactone is about 60 wt %-70 wt %; and a mass percentage of butyl cellosolve is about 10 wt %-15 wt %.

For example, N-methyl-2-pyrrolidone is a solvent to dissolve polyimide; butyl cellosolve is a solvent for guaranteeing the liquidity of the alignment material composition; and γ-butyrolactone is a solvent for ensuring the edge linearity of the alignment material composition.

N-methyl-2-pyrrolidone, γ-butyrolactone and butyl cellosolve are all organic solvents showing high boiling point. For example, the boiling point of N-methyl-2-pyrrolidone is 203° C.; the boiling point of γ-butyrolactone is 204° C.; and the boiling point of butyl cellosolve is 171.7° C.

For example, the preparation method of the alignment material composition comprises: dissolving about 5 wt %-10 wt % of polyimide resin into about 15 wt %-20 wt % of N-methyl-2-pyrrolidone, about 60 wt %-70 wt % of γ-butyrolactone and about 10 wt %-15 wt % of butyl cellosolve (ethylene glycol monobutyl ether); adding about 0.1 wt %-1 wt % of an organic additive after fully stirring; and intensively stirring to uniformly mix the components and then obtaining the alignment material composition.

For example, dissolving about 6 wt % of polyimide resin into about 16 wt % N-methyl-2-pyrrolidone, about 65 wt % of γ-butyrolactone and about 12 wt % of butyl cellosolve (ethylene glycol monobutyl ether); adding about 1 wt % of an organic additive after fully stirring; and the components are uniformly mixed by sufficient stirring to prepare the alignment material composition.

For example, polyimide resin is polyimide resin commonly used in the process of preparing the alignment material composition in the present field.

For example, the organic additive is capable of absorbing the energy of UV light, storing the absorbed energy, and finally converting the energy into environment-friendly heat for release. The organic additive almost does not absorb any visible light and then will not be stained and hence will not harm the quality of the alignment layer.

For example, the organic additive has a special molecular structure. There is an intramolecular hydrogen bond in the molecular structure. In a normal state, the intramolecular hydrogen bond in the organic additive is closed. Under the irradiation of about 290 nm-400 nm UV light, the organic additive will absorb the energy of the UV light; the intramolecular hydrogen bond is opened and the energy of the bond is released in the form of heat; and the organic additive is restored to the normal state again to continuously absorb the energy of the UV light for the next time. In other words, the organic additive absorbs the energy of external UV light, so as to protect the alignment material composition and other substances in a liquid crystal layer from the irradiation of the UV light energy and finally prevent the damage of the UV light on the liquid crystals and the alignment layer.

The organic additive has good thermal stability, chemical stability, optical stability and miscibility. The organic additive is inactive to react with other components and is not easy to be affected by the subsequent manufacturing processes of the LCD panel.

For example, the organic additive is a benzotriazole compound represented by the following formula:

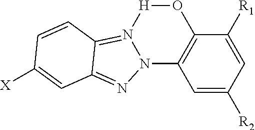

wherein, X is a hydrogen atom or a halogen atom, for example, X represents H, F, Cl, Br or I; R₁ represents H or C₄-C₁₂ alkyl isomer; and R₂ represents CH₃ or C₄-C₈ alkyl isomer.

For example, there is an intramolecular hydrogen bond between a hydrogen atom on a hydroxyl group of a benzene ring of the benzotriazole compound and a nitrogen atom on a triazole ring. Thus, a stable hexatomic ring is formed. When the benzotriazole compound absorbs UV light, the intramolecular hydrogen bond formed between the hydrogen atom on the hydroxyl group of the benzene ring and the nitrogen atom on the triazole ring is broken; intramolecular proton transfer occurs; and protons are transferred to the nitrogen atom to form tautomers. But the generated tautomers are not stable. Thus, excess energy may be released as heat, and the product will return to stable ground state.

For example, when the benzotriazole compound is irradiated by about 290 nm-400 nm UV light, the benzotriazole compound undergoes the following reaction:

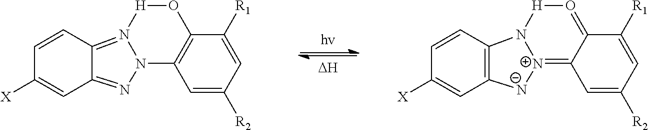

wherein, X represents H, F, Cl, Br or I; R₁ represents H or C₄-C₁₂ alkyl isomer; and R₂ represents CH₃ or C₄-C₈ alkyl isomer.

For example, the chemical formula of the organic additive is:

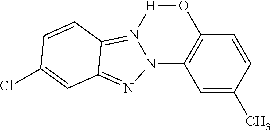

For example, a mass percentage of the organic additive is about 0.5 wt %-0.8 wt %. For example, a mass percentage of the organic additive may be 0.5 wt %, 0.6 wt %, 0.7 wt % or 0.8 wt %.

For example, organic matters being capable of absorbing UV light generally include: salicylates, benzophenones, benzotriazoles and triazines. For example, the salicylates mainly absorb UV light of about 280 nm-310 nm, and have low melting point and are easy to sublimate. For example, the benzophenones mainly absorb UV light of about 280 nm-320 nm, and have poor heat resistance and will be yellowish after long-term UV irradiation. For example, the triazines can absorb partial visible light and tend to be yellowish.

The benzotriazole compound adopted in the embodiments of the present disclosure has high melting point, good stability and high efficiency in absorbing UV light, and almost does not absorb visible light. When added into the alignment material composition, the benzotriazole compound will basically not be stained, has good intermiscibility with polymers in the alignment material composition, and has high stability. Considering that the subsequent application of the alignment material composition involves high-temperature treatment and alignment materials are required to be transparent and colorless, the benzotriazole compound is selected.

For example, a mass percentage of the polyimide resin is about 6 wt %-8 wt %. For example, a mass percentage of the polyimide resin is 6 wt %, 7 wt % or 8 wt %.

For example, the liquid crystal molecules may be damaged when irradiated by UV light, so it indicates that the damage to the liquid crystal molecules is more severe when the afterimage problem is severe and the afterimage level is higher. For example, in the embodiments of the present disclosure, the anti-UV effects of the alignment material composition detected after the addition of the organic additive into the alignment material composition is determined by the afterimage level.

TABLE 1

| Mass Percentage of Organic | | |
|---|---|---|
| Additive (wt %) | Mask | Afterimage Level |
| 0 | None | 3 |
| 0.4 | None | 1 |
| 0.6 | None | 0 |
| 0.8 | None | 1 |

For example, as shown in Table 1, when the mass percentage of the organic additive is respectively 0 wt %, 0.4 wt %, 0.6 wt % and 0.8 wt %, when no mask is applied, corresponding afterimage levels are respectively 3, 1, 0 and 1.

An embodiment of the present disclosure provides an LCD panel. For example, as illustrated in FIG. 2 which is a schematic structural sectional view of the LCD panel provided by the embodiment of the present disclosure, the LCD panel comprises: a first substrate 10 and a second substrate 11 opposed to each other, liquid crystals 12 disposed between the first substrate 10 and the second substrate 12, and an alignment layer 13 disposed on at least one surface of the first substrate 10 and the second substrate 11 close to the liquid crystals. The alignment layer 13 comprises the alignment material composition described in the first embodiment. The first substrate 10 and the second substrate 11 are, for example, combined together via sealant to form a liquid crystal cell.

For example, the alignment layer 13 may have a multi-layered structure. The organic additive is disposed in a layer of the alignment layer 13 away from the liquid crystals 12, being capable of absorbing UV light.

For example, the polyimide resin is disposed in a layer of the alignment layer 13 close to the liquid crystals, so as to align the liquid crystals 12.

For example, the liquid crystals 12 are cholesteric liquid crystals, nematic liquid crystals or smectic liquid crystals as required.

For example, the first substrate 10 is a color filter (CF) substrate including a CF structure (e.g., CF units and black matrixes (BMs)), and the second substrate 11 is an array substrate including an array structure (e.g., gate lines, data lines, thin-film transistors (TFTs) and pixel electrodes).

For example, the LCD panel further comprises main spacers 15 and auxiliary spacers 16 disposed between the first substrate 10 and the second substrate 11 to support the first substrate and the second substrate. The height of the auxiliary spacer 16 is smaller than that of the main spacer 15. In normal conditions, the main spacer 15 supports the substrates. When the extrusion force of the outside environment to the liquid crystal cell is too large so that the auxiliary spacer 16 abuts against the substrate opposite to the auxiliary spacer, the auxiliary spacer 16 may support the substrate.

An embodiment of the present disclosure further provides a display device, which comprises the foregoing display panel. Other structures in the display device may refer to the conventional technique. The display device may, for example, be any product or component with display function such as a mobile phone, a tablet PC, a TV, a display, a notebook computer, a digital picture frame or a navigator.

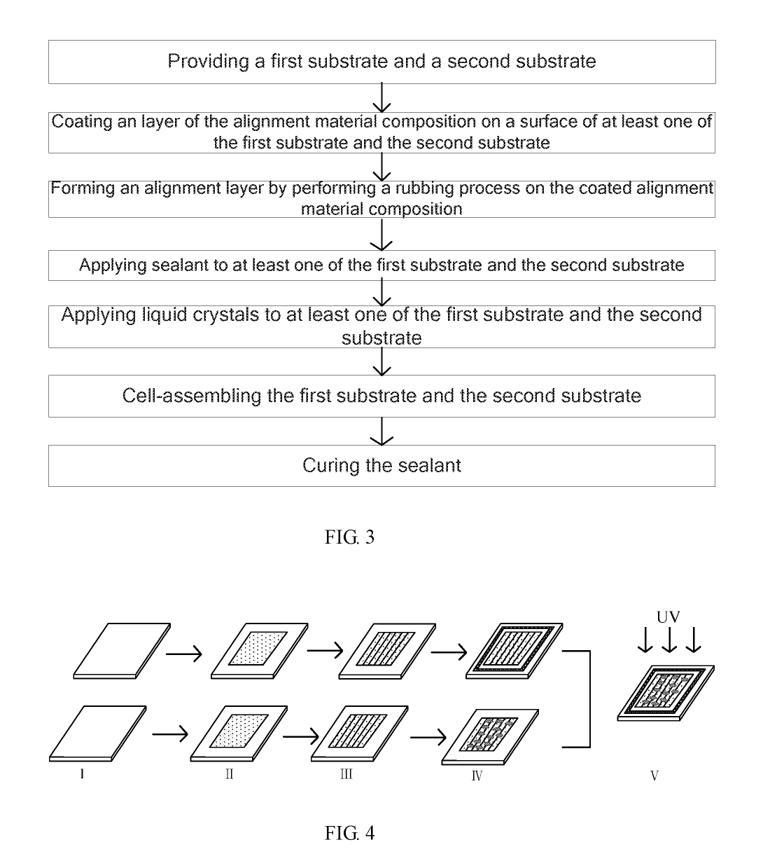

The embodiments of the present disclosure further provide a method for manufacturing an LCD panel. For example, as illustrated in FIG. 3 which is a flow diagram of the method for manufacturing the LCD panel, the manufacturing method comprises: providing a first substrate and a second substrate; coating one layer of the alignment material composition in the first embodiment on at least one surface of the first substrate or the second substrate; forming an alignment layer by performing a rubbing process on the coated alignment material composition; applying sealant to at least one of the first substrate and the second substrate; applying liquid crystals to at least one of the first substrate and the second substrate; cell-assembling the first substrate and the second substrate; and curing the sealant.

For example, the film forming process of the alignment material composition comprises: coating the alignment material composition on a surface of at least one of the first substrate and the second substrate; removing partial organic solvent by pre-curing at the temperature of about 60° C.-100° C.; performing primary curing at the temperature of about 200° C.-230° C.; and forming the alignment layer by performing a rubbing process on the alignment material composition.

For example, in the manufacturing method, the liquid crystals may be firstly applied to the second substrate and then cell-assembling the first substrate and the second substrate to form the liquid crystal cell, or the first substrate and the second substrate may be cell-assembled first and then the liquid crystals are filled into the liquid crystal cell.

For example, the curing of the sealant includes UV pre-curing at first and then primary thermocuring. For example, the sealant is irradiated by 290 nm-400 nm UV light for the pre-curing of the sealant. For example, the primary thermocuring process may adopt resistance wire heating, infrared heating, etc.

For example, before coating the alignment material composition on at least one of the first substrate or the second substrate, the method further comprises: respectively forming a CF structure and an array structure on the first substrate (e.g., a CF substrate) and the second substrate (e.g., an array substrate).

For example, as illustrated in FIG. 4 which is a diagram illustrating the manufacturing process of the LCD panel, provided by the embodiment of the present disclosure, the method comprises the following steps:

I. Providing a first substrate (e.g., a CF substrate) and a second substrate (e.g., an array substrate), and respectively forming a CF structure and an array structure on the first substrate and the second substrate.

II. Respectively coating the alignment material composition of the first embodiment on surfaces of the first substrate and the second substrate.

III. Forming an alignment layer by performing a rubbing process on the alignment material compositions coated on the surfaces of the first substrate and the second substrate.

IV. Applying sealant to the first substrate and applying liquid crystals to the second substrate.

V. Forming a liquid crystal cell by the cell-assembly of the first substrate and the second substrate, and adopting UV light to irradiate the sealant for pre-curing. Compared with the conventional manufacturing process, the step S4 in the embodiment of the present disclosure omits the application of masks, so the method reduces the production cost of the LCD panel, simplifies the manufacturing process of sealant pre-curing, improves the capability of the LCD panel in resisting UV light irradiation, and improves the product quality.

For example, after all the above processes are completed, the sealant is subjected to primary thermocuring.

The alignment material composition, the LCD panel, the manufacturing method thereof and the display device, provided by the embodiments of the present disclosure, have at least one of the following advantages: the alignment material composition not only can form the alignment layer by alignment process but also can effectively protect the liquid crystal molecules from UV light irradiation. Thus, when the alignment material composition is applied to the LCD panel, corresponding UV light masks are not required to be manufactured for LCD panels with different sizes of display regions. Therefore, the production cost of the LCD panel is reduced; the manufacturing process of sealant pre-curing is simplified; the capability of the LCD panel in resisting UV light irradiation is improved; and the product quality is improved.

The following matters should be noted:

(1) The accompanying drawings of the embodiments of the present disclosure only involve the structures relevant to the embodiments of the present disclosure, and other structures may refer to the conventional technique;

(2) For clarity, in the accompanying drawings of the embodiments of the present disclosure, the thickness of layers or regions is enlarged or reduced, namely the accompanying drawings are not drawn according to actual scale. It should be understood that: when an element such as a layer, a film, a region or a substrate is referred to as being disposed “on” or “beneath” another element, the element may be “directly” disposed “on” or “beneath” the other element, or an intermediate element may be provided; and

(3) The embodiments of the present disclosure and the characteristics in the embodiments may be mutually combined to obtain new embodiments without conflict.

The present application claims the priority of the Chinese Patent Application No. 201611072258.8 filed on Nov. 29, 2016, which is incorporated herein by reference as part of the disclosure of the present application.

1. An alignment material composition, comprising:
about 89 wt %-94.9 wt % of an organic solvent;
about 0.1 wt %-1 wt % of an organic additive; and
about 5 wt-10 wt % of polyimide resin,
wherein the organic additive is capable of absorbing ultraviolet (UV) light of wavelength from about 290 nm to about 400 nm.

2. The alignment material composition according to claim 1, wherein the organic additive comprises a benzotriazole compound represented by following formula: 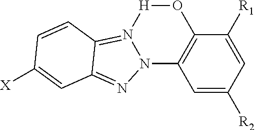
wherein, X is selected from the group consisting of H, F, Cl, Br and I; R1 is selected from the group consisting of H and C₄-C₁₂ alkyl; and R₂ is selected from the group consisting of CH₃ and C₄-C₈ alkyl.

3. The alignment material composition according to claim 2, wherein the organic additive comprises:

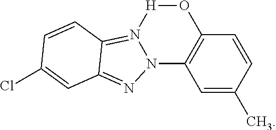

4. The alignment material composition according to claim 1, wherein a mass percentage of the organic additive to the alignment material composition is about 0.5 wt %-0.8 wt %.

5. The alignment material composition according to claim 4, wherein a mass percentage of the organic additive to the alignment material composition is about 0.6 wt %.

6. The alignment material composition according to claim 1, wherein a mass percentage of the polyimide resin to the alignment material composition is about 6 wt %-8 wt %.

7. The alignment material composition according to claim 1, wherein the organic solvent comprises at least one selected from the group consisting of N-methyl-2-pyrrolidone, γ-butyrolactone and butyl cellosolve.

8. The alignment material composition according to claim 7, wherein the organic solvent comprises N-methyl-2-pyrrolidone, γ-butyrolactone and butyl cellosolve; and in the alignment material composition, a mass percentage of N-methyl-2-pyrrolidone is about 15 wt %-20 wt %, a mass percentage of γ-butyrolactone is about 60 wt %-70 wt %, and a mass percentage of butyl cellosolve is about 10 wt %-15 wt %.

9. A liquid crystal display (LCD) panel, comprising:
a first substrate and a second substrate opposed to each other;
liquid crystals between the first substrate and the second substrate; and
an alignment layer disposed on a surface of at least one of the first substrate and the second substrate, which surface is close to the liquid crystals, wherein
the alignment layer comprises the alignment material composition according to claim 1.

10. The LCD panel according to claim 9, wherein the alignment layer has a multi-layered structure; and the organic additive is disposed in a layer structure of the alignment layer, which layer structure is away from the liquid crystals and is capable of absorbing UV light.

11. The LCD panel according to claim 10, wherein the polyimide resin is disposed in a layer structure of the alignment layer, which layer structure is close to the liquid crystals, and is capable of aligning the liquid crystals.

12. The LCD panel according to claim 10, wherein the first substrate is an array substrate and the second substrate is a color filter (CF) substrate.

13. A display device, comprising the LCD panel according to claim 9.

14. A method for manufacturing a liquid crystal display (LCD) panel, comprising:
providing a first substrate and a second substrate;
coating an layer of an alignment material composition on a surface of at least one of the first substrate and the second substrate, wherein the alignment material composition comprises about 89 wt %-94.9 wt % of an organic solvent, about 0.1 wt %-1 wt % of an organic additive and about 5 wt %-10 wt % of polyimide resin, wherein the organic additive is capable of absorbing ultraviolet (UV) light of wavelength from about 290 nm to about 400 nm;
forming an alignment layer by performing a rubbing process on the coated alignment material composition;
applying a sealant to at least one of the first substrate and the second substrate;
applying liquid crystals to at least one of the first substrate and the second substrate;
cell-assembling the first substrate and the second substrate; and
curing the sealant.

15. The manufacturing method according to claim 14, wherein curing of the sealant includes UV pre-curing and primary thermocuring.

16. The manufacturing method according to claim 14, wherein the first substrate and the second substrate are respectively a color filter (CF) substrate and an array substrate; and before coating the layer of the alignment material composition on the surface of at least one of the first substrate and the second substrate, a color filter (CF) structure and an array structure are respectively formed on the first substrate and the second substrate.

17. The alignment material composition according to claim 2, wherein a mass percentage of the organic additive to the alignment material composition is about 0.5 wt %-0.8 wt %.

18. The alignment material composition according to claim 3, wherein a mass percentage of the organic additive to the alignment material composition is about 0.5 wt %-0.8 wt %.

19. The alignment material composition according to claim 2, wherein a mass percentage of the polyimide resin to the alignment material composition is about 6 wt %-8 wt %.

20. The alignment material composition according to claim 3, wherein a mass percentage of the polyimide resin to the alignment material composition is about 6 wt %-8 wt %.
